(19) United States
(12) Patent Application Publication
(10) Pub. No.: US 2011/0272500 A1
(43) Pub. Date: Nov. 10, 2011

(54) Adjustable Eye Ball Fitting

(76) Inventor: Brandal Johnston, Horn Lake, MS (US)

(21) Appl. No.: 13/101,116

(22) Filed: May 4, 2011

Related U.S. Application Data
(60) Provisional application No. 61/343,776, filed on May 4, 2010.

(51) Int. Cl. B05B 15/08

(52) U.S. Cl. 239/587.4

(57) ABSTRACT

Herein disclosed is a novel coupling device to connect a water jet outlet, such as a pool or spa jet to a pipe. A flexible seal engages the outer circumference of the inlet pipe and two flat surfaces that allow application of an appropriate binding agent for securing the pipe, and surface adapted to couple with the water jet outlet. The invention allows a contractor to install a pool or spa jet perpendicular to the surface of the pool wall and adjust position of the pool jet so that it is at the desired height and angle prior to applying the final plaster coat. The coupling provides a watertight seal and sufficient surface area for pipe-fitting glue adhesion.

This application claims the benefit of provisional U.S. Patent application Ser. No. 61/343,776 filed on May 4, 2010 entitled Minute Mat, Memory Jack, Stick It Memory Gate Adjustable Eye Ball, Offset Adjustable Eyeball herein incorporated by reference.

### BACKGROUND OF THE INVENTION

This invention relates generally pool or spa jet couplings. More specifically, this invention relates to joint fixtures used to couple a pipe and an adjustable eyeball water jet outlet when used in concrete or gunite pools and spas.

During construction of a concrete gunite lined pool, the builder generally installs several 1½-inch PVC pipes in the wall of the swimming pool before gunite or concrete is applied. These pipes generally return the water back into the pool. To start, these pipes are cut about 2′ to 2′½ long. Each end is covered or taped over with duct tape to keep the pipe free of dirt or concrete. The pipes are installed with each end protruding out of the gunite wall. One end sticks out of the wall toward the center of the pool and is placed perpendicular to the wall surface. The other end comes out the back of the pool wall. This pipe is typically wired in place against the steel rebar and counter sunk into the earth about six inches to maintain a proper perpendicular orientation to the wall surface.

Next the gunite is applied directly to the earth. The gunite is applied having a thick consistency, generally referred to as a having a 2″ inch slump. This gives the ability to stack the gunite up the wall using the earth and rebar along with the pipes as a support for the gunite is it cures. Later the plumber will dig down to the back end of the pipe and connect with additional pipe and run it to the filter system.

During the gunite process the weight of the concrete pushes down on the pipes. If the steel reinforcement is not supported adequately from the floor it will also settle, dragging the pipe down with it. Unfortunately it is common for the pipes to be inadequately supported due to use of inexperienced labor or unintentional shifting of the pipe during gunite application. If not installed correctly, the pipe can end up angled downward as much as 35 degrees from perpendicular to the wall's surface.

Another problem occurs where jets are installed above seating areas or steps of a pool or spa. It's common to end up with a pipe to close to the top of a step or bench. Ideally the pipe should be two or three inches above a bench or step to help with the cleaning of the top surface of each. The extra water flow blows off the dirt during normal operations of the pool. It's also placed there for water flow across the human body simulating a spa jet. Unfortunately, the pipe and corresponding jet are often placed too low, exiting below or at the same level of the bench.

Current eyeball fittings slip straight into the pipe leaving the eyeball support housing pointing downward even with the top of the steps. To remedy this problem, the concrete and steel reinforcement must be removed, additional pipe and various additional joints installed and the solution may even require heating and bending the pipe just to move the jet up three or four inches and keep the jet perpendicular to the wall surface.

The added labor and materials needed to correct poorly placed return pipes adds additional expense and delays construction.

A need exists for an inexpensive, robust, simple to use fixture that can couple an angled and/or offset pipe to a pool or spa jet allowing the spa jet to be positioned at an appropriate height from the seat for proper function and provide an esthetically pleasing finished product.

### BRIEF SUMMARY OF THE INVENTION

The invention provides a means to couple a water jet outlet, such as a pool or spa jet to a pipe. The invention possesses a flexible seal that engages the outer circumference of the inlet pipe and two flat surfaces that allow application of an appropriate binding agent for securing the pipe, and surface adapted to couple with the water jet outlet. The invention allows a contractor to install a pool or spa jet perpendicular to the surface of the pool wall and adjust position of the pool jet so that it is at the desired height prior to applying the final plaster coat. The coupling allows for a watertight seal and surface area for pipe-fitting glue adhesion.

### BRIEF DESCRIPTION OF THE DRAWINGS

The invention is illustrated by the accompanying drawings, in which:

FIG. 1 is a rear perspective view of a first embodiment of the invention showing an upper water jet outlet housing, a connecting conduit and a lower coupling housing with a compliant sealing surface.

FIG. 2 is a rear view of the first embodiment of the invention.

FIG. 3 is a cross-sectional view of the upper water jet outlet housing of FIG. 2 taken at section line 3-3 in FIG. 2.

FIG. 4 is a cross-sectional view of the lower coupling of FIG. 2 taken at section line 4-4 in FIG. 2.

FIG. 5 is a cross-sectional view of the seal of FIG. 2 taken at section line 4-4 in

FIG. 2.

FIG. 6 is a cross-sectional view of the seal mounting portion of the lower housing of FIG. 2 taken at section line 4-4 in FIG. 2.

FIG. 7 is a perspective view of the lower housing with the seal removed.

FIG. 8 is a perspective view of a second embodiment of the invention, having the water jet outlet and inlet pipe seal within the same housing.

FIG. 9 is a rear view of second embodiment of the invention.

FIG. 10 is a cross-sectional view of the second embodiment of the invention of FIG. 9 taken at section line 10-10 in FIG. 9.

### DETAILED DESCRIPTION OF THE INVENTION

The drawings illustrate an invention that enables an individual position a pool jet outlet perpendicular to the pool wall and adjust the position of the pool jet along the pool wall even when the inlet pipe is not perpendicular to the pool wall or in the desired location.

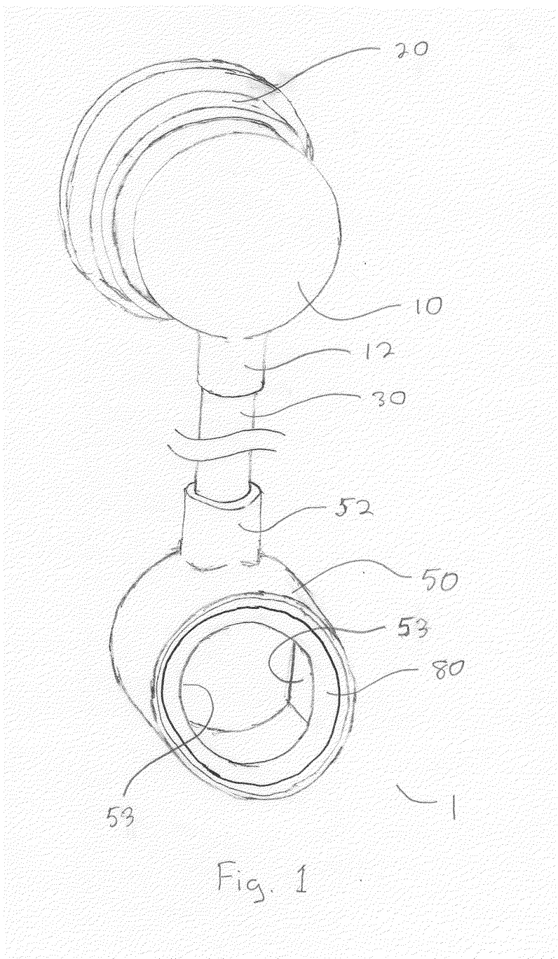

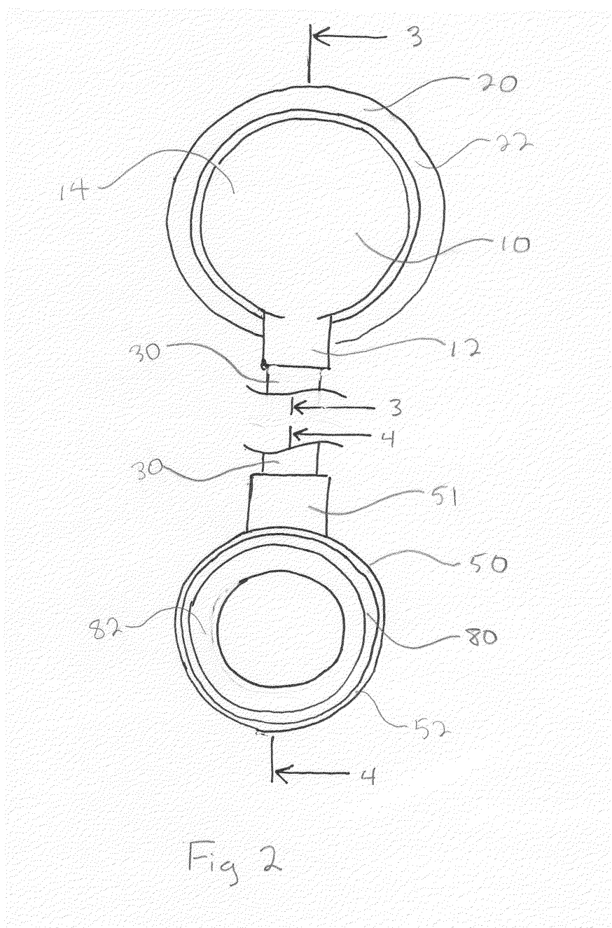

FIG. 1 is a rear perspective view of a first embodiment of the invention 1 showing an upper spa jet housing 10, a connecting conduit 30, and a lower coupling housing 50 with a compliant seal 80. The spa jet mounting plate 20 is threadably connected with the upper spa jet housing 10. The spa jet housing 10 contains a connecting pipe coupling 12 that receives a connecting pipe 30. Connecting pipe 30 is received by lower coupling housing coupling 51. The lower coupling housing 50 contains a semi-flexible seal 80 and flat glue surfaces 53.

FIG. 2 is a rear view of the invention showing the rear surface 22 of the spa jet mounting plate 20, the rear surface 14 of the upper spa jet housing 10, the outer sealing surface 82 of the seal 80 and the outer edge rear surface 52 of the lower coupling housing 50.

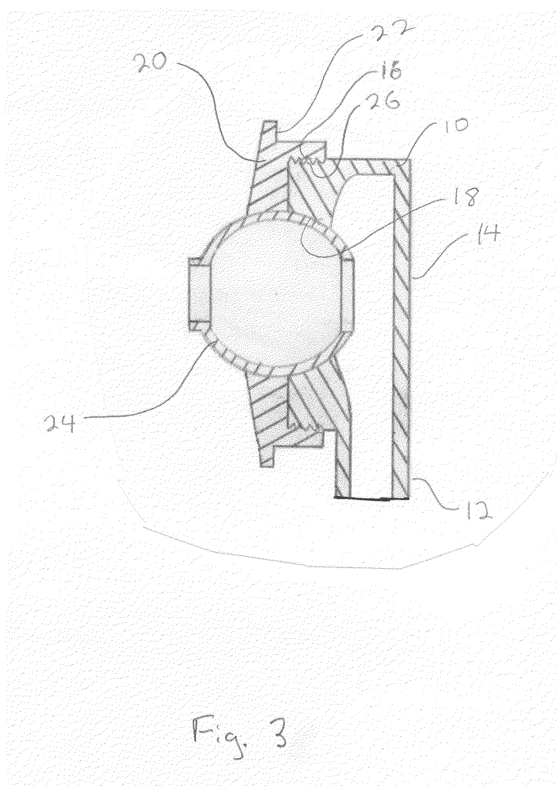

FIG. 3 is a cross-sectional view of the upper spa jet housing 10 of FIG. 2 taken at section line 3-3 in FIG. 2 showing the eye ball jet outlet nozzle 24 and jet mounting plate threads 26 and upper water jet housing threads 16. Here, the housing possesses threads 16 and a nozzle surface 18 complimentary to the water jet nozzle 24. The housing threads 16 engage the water jet mounting plate threads 26 to secure the nozzle 24 to the housing 10. A connecting pipe can be inserted into the connecting pipe coupling 12.

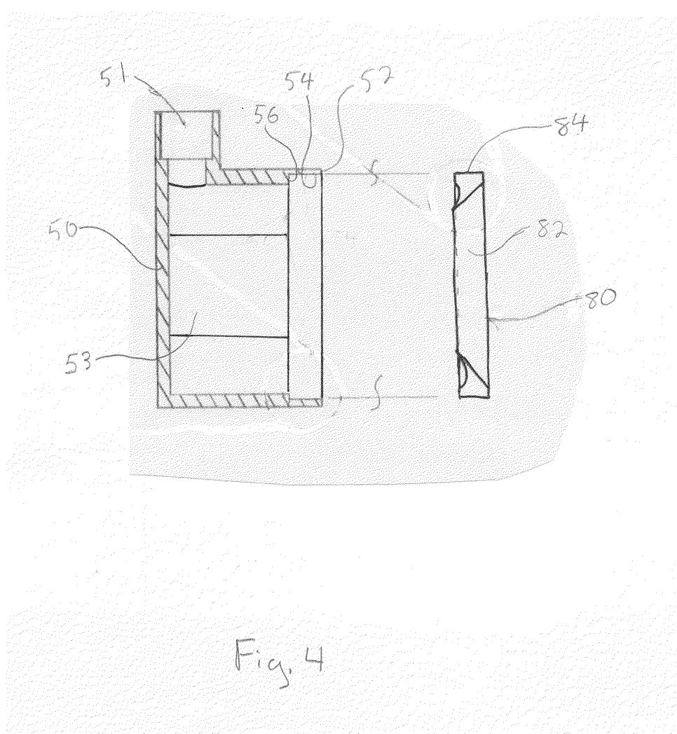

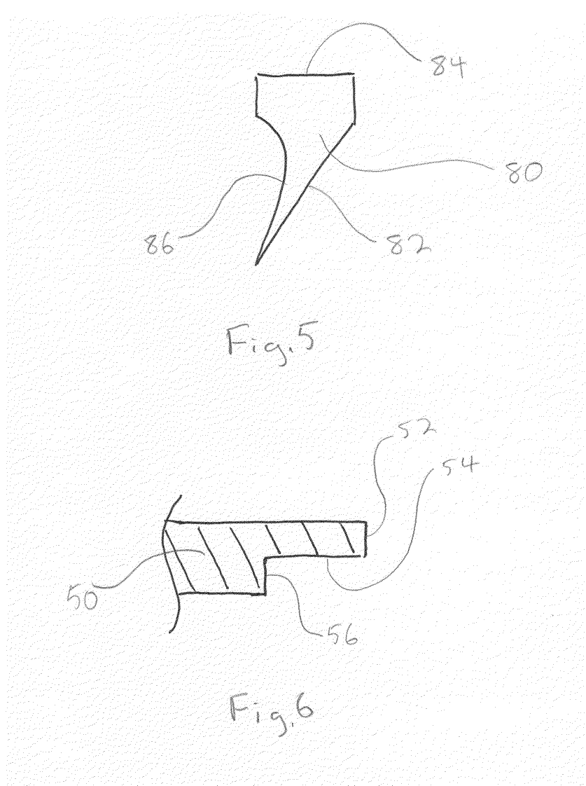

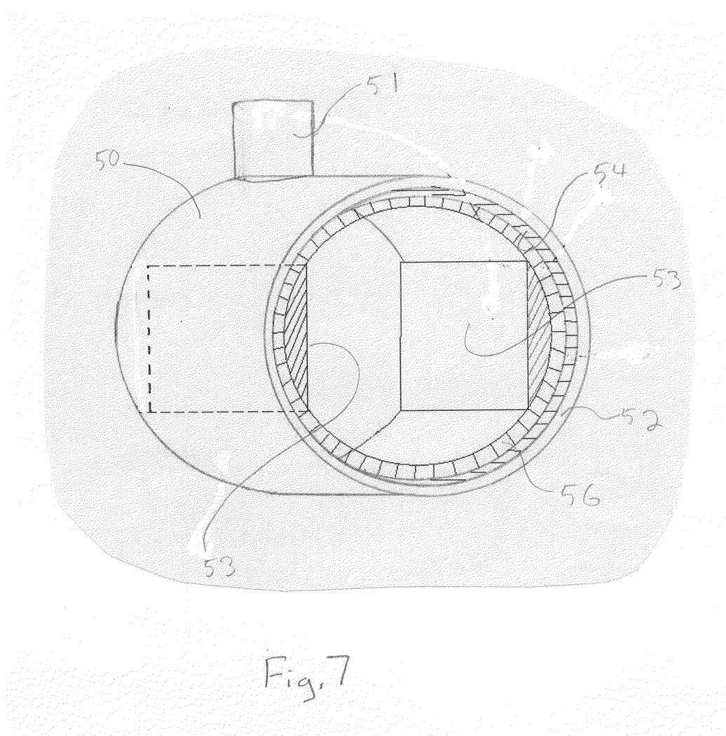

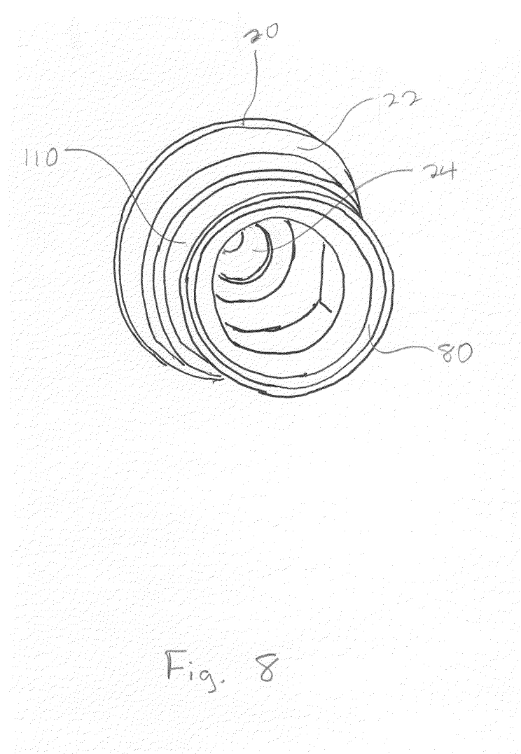

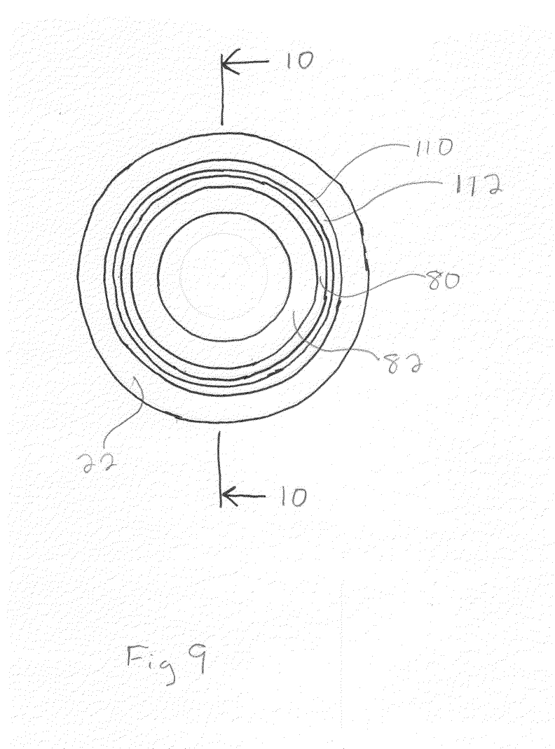

FIG. 4 is a cross-sectional view of the lower coupling housing 50 of FIG. 2 taken at section line 4-4 in FIG. 2. The lower housing 50 possesses a connecting pipe coupler 51 adapted to receive a coupling pipe 30. The seal 80 is received by the stepped surface 54 and prevented from moving further into the housing by a rear inner rear surface 56. The seal 80 is affixed to the housing 50, generally with a glue or cement on the outer circumferential seal surface 84 and housing stepped surface 54. Flat glue surfaces 53 on opposing sides of the housing 50 provide two parallel surfaces for gluing the inlet pipe to the housing. The vertical interior diameter is larger than the outer dimensions of the inlet pipe of the lower coupling housing 50 allows the housing to accept the inlet pipe at a variety of vertical angles.

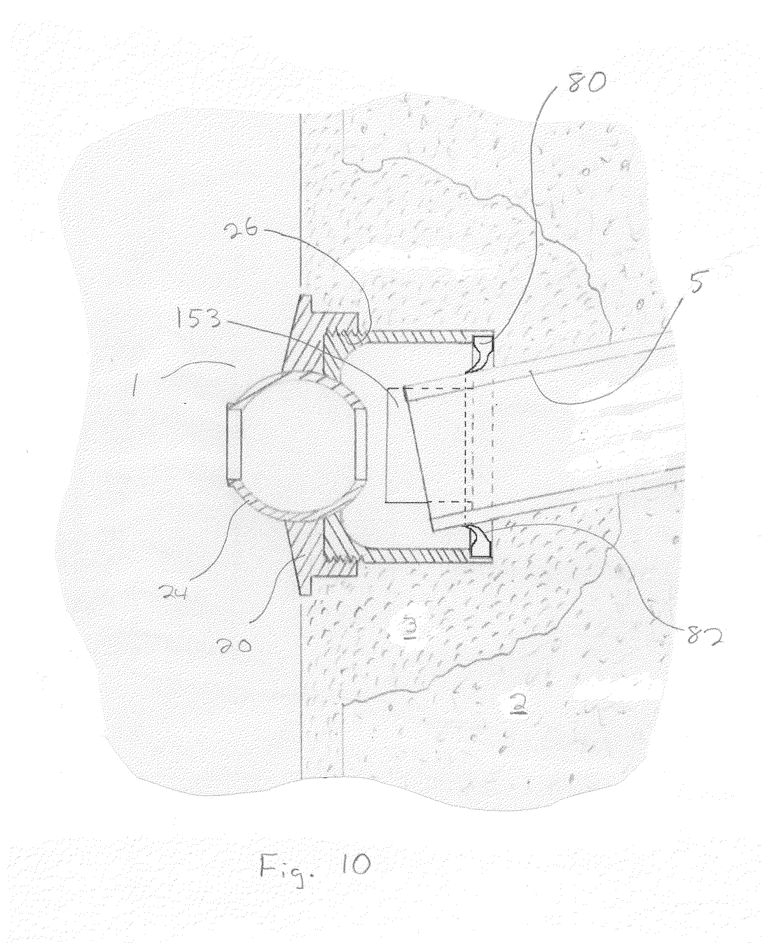

FIG. 5 is a cross-sectional view of the seal 80 of FIG. 2 taken at section line 4-4 in FIG. 2. The beveled surface 82 of the seal 80 contacts the outer surface of the inlet pipe preventing egress of water from the housing 50. Water pressure on the rear seal surface 86 provides additional force against the inlet pipe aiding in sealing water in the housing 50.

FIG. 6 is a cross-sectional view of the seal mounting portion of the lower housing 50 of FIG. 2 taken at section line 4-4 in FIG. 2.

FIG. 7 is a perspective view of the lower housing 50 with the seal 80 removed. Parallel surfaces 53 allow for gluing of the inlet pipe while allowing the housing to be positioned at the desired angle by allowing vertical movement of the inlet pipe.

FIG. 8 is a perspective view of a second embodiment of the invention, having the water jet outlet 20, nozzle 24 and inlet pipe seal 80 within the same housing.

FIG. 9 is a rear view of second embodiment of the invention showing the nozzle mounting plate rear surface 22, angled sealing surface 82 of the seal 80 and outer rear surface of the housing 110.

FIG. 10 is a cross-sectional view of the second embodiment of the invention of FIG. 9 taken at section line 10-10 in FIG. 9 showing the gunite 2, plaster 3, and inlet pipe 5. The parallel flat surfaces 153 allow for adequate contact area with the inlet pipe 5 for sufficient glue adhesion strength. The seal 80 and its outer angled sealing surface 82 seal against the outer surface of the pipe 5. The gunite 2 and plaster 3, once applied around the coupling 1, provide additional support to the coupling 1 and prevent any other leaks that may occur.

Preferably the invention 1 housings 10, 50 or 110 and seal 80 are constructed from PVC. Other suitable plastics may also be used where appropriate.

What is claimed is:

1. A water jet outlet to pipe coupling device for coupling a water jet outlet to a plastic pipe of a desired diameter comprising:
A housing adapted on a first side to receive a water jet outlet;
A flexible sealing surface that makes contact around the circumference of said plastic pipe and connected to a second side of said housing; and
Two opposing parallel surfaces set at a distance equal to said plastic pipe's desired diameter connected to said housing.
